(19) United States
(12) Patent Application Publication
(10) Pub. No.: US 2017/0023687 A1
(43) Pub. Date: Jan. 26, 2017

(54) Fracture Surface Extraction from Image Volumes Computed from Passive Seismic Traces

(71) Applicant: Global Ambient Seismic, Inc., Missouri City, TX (US)

(72) Inventors: Charles John Sicking, Plano, TX (US); Dylan Matthew Copeland, Wylie, TX (US)

(73) Assignee: Global Ambient Seismic, Inc., Missouri City, TX (US)

(21) Appl. No.: 15/143,182

(22) Filed: Apr. 29, 2016

Related U.S. Application Data
(60) Provisional application No. 62/194,604, filed on Jul. 20, 2015.

(51) Int. Cl. G01V 1/30; G01V 1/28

(52) U.S. Cl. CPC G01V 1/302; G01V 1/288; G01V 2210/65; G01V 2210/1234

(57) ABSTRACT

The invention comprises a method of imaging a volume of the earth's subsurface. A selected volume of the earth's subsurface is divided into a three-dimensional grid of voxels. Seismic signals representing seismic energy emanating from the earth's subsurface and detected by sensors deployed in proximity to said selected subsurface volume and conducted to a recorder for recording. The recorded signals are transformed into a grid of discrete voxel signals representing energy emanating from voxels included in said three-dimensional grid of voxels in the earth's subsurface. A smooth analytic function is defined in three dimensional space based on the grid of discrete voxel signals; and fracture surfaces are derived from the smooth analytic function.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF INVENTION

Field of the Invention

The invention relates generally to the field of seismic data acquisition and processing. More specifically, the invention relates to systems and methods for acquiring and processing passive seismic data, which may also be referred to as microseismic data.

Background Art

Passive seismic emission tomography (“SET”) is a process in which an array of seismic sensors is deployed in a selected pattern and seismic energy that emanates from within the earth's subsurface is detected by the sensors. The sensor output signals are processed to reveal various characteristics of the earth's subsurface. Applications for passive seismic emission tomography have included determining movement of reservoir fluids in subsurface petroleum producing reservoirs, and monitoring of movement of proppant-carrying fluid injected into subsurface reservoirs to increase the flow of production fluids.

### SUMMARY OF INVENTION

The invention comprises a method for extracting fracture surfaces from passive seismic data. A selected volume of the earth's subsurface is divided into a three-dimensional grid of voxels, typically a Cartesian grid. Seismic energy emanating from the earth's subsurface is detected by sensors deployed in proximity to the selected subsurface volume and converted to seismic signals that are conducted to a recording unit for recording. The recorded signals are transformed into a grid of discrete voxel signals representing the energy emanating from voxels included in said grid of voxels in the earth's subsurface. A smooth analytic function is defined in three spatial dimensions based on the grid of discrete voxel signals. Fracture surfaces are derived from the smooth analytic function. Other aspects and advantages of the invention will be apparent from the following description and the appended claims.

### BRIEF DESCRIPTION OF DRAWINGS

FIGS. 1A and 1B illustrate an example of the invention.

FIG. 2 is a flow chart of an example method for performing the invention.

FIG. 3 shows a programmable computer, display and computer readable media.

### DETAILED DESCRIPTION

The invention will now be described in detail with reference to the accompanying drawings. In describing the examples, specific details are set forth in order to provide a thorough understanding of the invention. However, it will be apparent to those skilled in the art that the invention may be practiced without some or all of such specific details. In other instances, well-known features and/or process steps have not been described in detail so as not to unnecessarily obscure the invention.

Generally, in a method according to the invention, an array of seismic sensors is deployed in a selected pattern, typically on or near the earth's surface, and seismic energy that emanates from seismic events occurring in the earth's subsurface is detected by the sensors to generate “passive” seismic signals in order to image a selected volume in the earth's subsurface. “Passive” seismic signals are thus distinguishable from “active” or “controlled source” seismic signals, which are produced by actuating a seismic energy source having controllable actuation timing, and in many cases controllable spectral content. Passive seismic signal recordings are typically continuous for long periods of time (hours or days), whereas active seismic methods record only for the time during which a signal is being generated and the signal travels downwardly in the subsurface, is reflected from subsurface reflecting interfaces and back to the surface (typically 20 seconds or less for each recording cycle). Methods that use passive seismic signals to image the earth's subsurface are typically referred to as seismic emission tomography (“SET”). The present invention may be performed to identify fracture surfaces in any selected volume of the earth's subsurface. However, the invention may typically be performed to identify fracture surfaces in the vicinity of a wellbore.

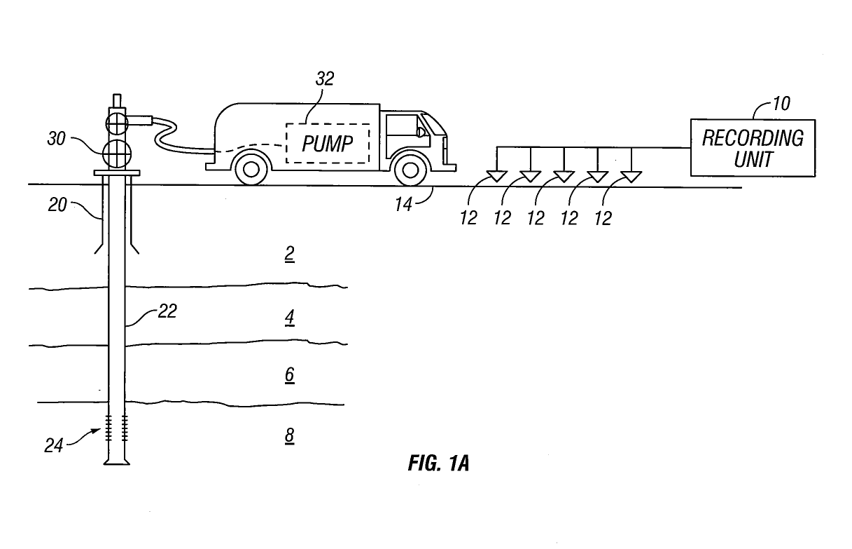

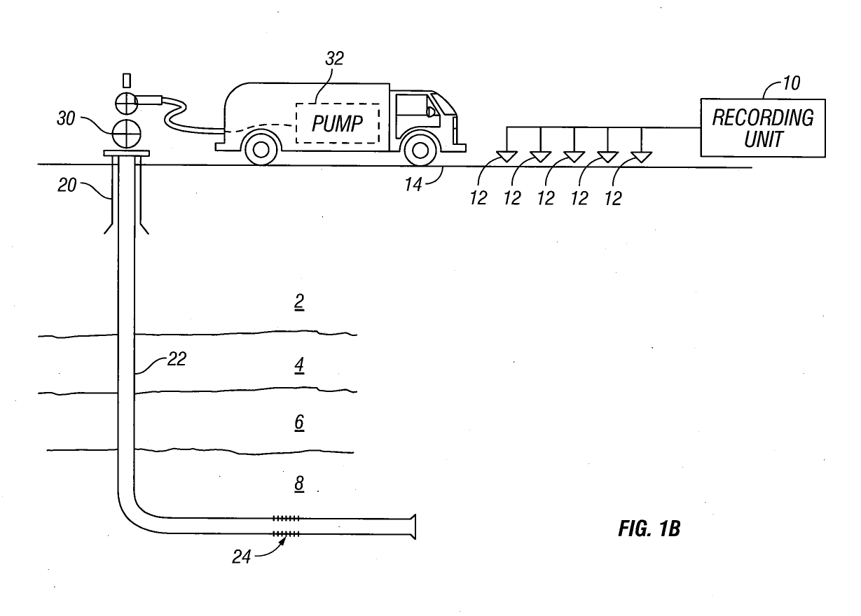

FIGS. 1A and 1B each show a wellbore 20 drilled through subsurface formations 2, 4, 6 and 8. In this example, one of the subsurface formations, shown as formation 8 may be a hydrocarbon producing formation. A wellbore tubing 22 including perforations 24 for receiving fluid from the hydrocarbon producing formation 8 is deployed in the wellbore 20. The wellbore tubing 22 is connected to a surface wellhead 30 including an assembly of valves (not indicated separately) for controlling fluid flow. Wellhead 30 may be connected to pumping unit 32, which may be used for pumping fluid down the wellbore 22 into the subsurface formations, particularly hydrocarbon producing formation 8. FIG. 1A shows a vertical well. FIG. 1B is the same as FIG. 1A, except that FIG. 1B illustrates a horizontal well. Drilling technology has evolved to allow wells to be drilled along virtually any direction or azimuth. By drilling horizontally or non-vertically through a formation, the extent of the formation in contact with the wellbore can be much greater than is possible with vertically drilled wells, thereby increasing significantly the total volume of the subsurface from which hydrocarbons can be produced.

Typically, wellbore 20 is subjected to a fracturing operation in which hydraulic fracturing fluid is injected into wellbore 20 through perforations 24 and into geologic formation 8. In the fracturing operation, the wellhead 30 may be hydraulically connected to a fracture pumping unit 32. The fracture pumping unit 32 pumps fluid down the wellbore 20 and into the subsurface formations, particularly the hydrocarbon producing formation 8, through perforations 24. The movement of fluid into the hydrocarbon producing formation 8 at a pressure which exceeds the fracture pressure of the hydrocarbon producing formation 8 causes the formation to rupture and develop fissures. The fracture pressure is generally related to the overburden pressure, i.e., the pressure exerted by the weight of all the formations above the hydrocarbon producing formation. The fluid pumped into the hydrocarbon producing formation 8 will normally include proppants, i.e., solid particles having a selected size. In propped fracturing operations, the particles of the proppant move into fissures formed in the hydrocarbon producing formation 8 and remain in the fissures after the fluid pressure is reduced below the fracture pressure of the formation, thereby propping the fissures open for subsequent fluid production from the hydrocarbon producing formation, thus substantially increasing the productive capacity of the wellbore 20.

FIGS. 1A and 1B each show an array of sensors 12 arranged proximate to the earth's surface 14 to detect seismic energy originating from the subsurface. In marine applications, the array of seismic sensors 12 could be arranged at or proximate to the water bottom in a cable device known as an “ocean bottom cable”. Data acquisition configurations other than that shown in FIGS. 1A and 1B may be employed. For example, surface sensors may be employed in conjunction with downhole sensors, and downhole sensors may be employed in another wellbore in addition to, or instead of, wellbore 20. Downhole sensors may also be employed instead of surface sensors.

The seismic sensors 12 generate electrical, magnetic or optical signals in response to detected particle motion, velocity or acceleration. A recording unit 10 is in signal communication with the seismic sensors 12 for making a time-indexed recording of the seismic signals detected by each seismic sensor 12. In some examples the seismic sensors 12 are geophones, In other examples, the seismic sensors 12 may be accelerometers or other sensing devices known in the art that are responsive to motion, velocity or acceleration of the earth's surface or formations proximate to the particular sensor. Some types of seismic sensors may include a plurality of mutually orthogonally arranged particle motion responsive sensing elements to detect particle motion along different directions, for example, shear wave motion. Accordingly, the type of seismic sensor is not a limit on the scope of the present invention.

In one example, the seismic sensors may be arranged in a radially extending, spoke-like pattern, with the center of the pattern disposed approximately about the surface position of the wellbore 20. In this example, the sensors 12 are arranged in directions substantially along a direction of propagation of acoustic energy that may be generated by noise sources near the wellhead 30, which may be attenuated by frequency-wavenumber (fk) filtering. The seismic sensors 12 may also be arranged in other configurations, such as, for example, the orthogonal array configuration illustrated in U.S. patent application Ser. No. 13/277,189, filed on Oct. 19, 2011 to Riley et al. and published on Apr. 25, 2013 as Patent Publication No. 2013/0100769, which is incorporated herein by reference.

In some examples, the seismic sensors 12 may be arranged in sub-groups, with spacing between individual sensors in each of the sub-groups being less than about one-half the expected wavelength of the seismic energy from the earth's subsurface that is intended to be detected. Signals from all the seismic sensors 12 in one or more of the sub-groups may be added or summed to reduce the effects of noise in the detected signals.

The seismic signals recorded from each of the sensors 12 may be processed first by certain procedures well known in the art of seismic data processing, including the summing described above, and various forms of filtering and other processing techniques for noise reduction and/or signal enhancement known to those of ordinary skill in the art.

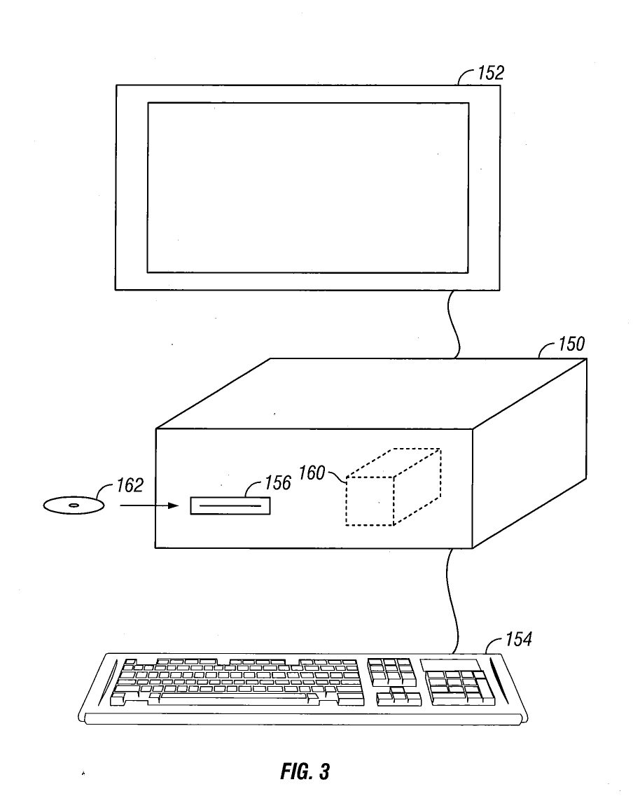

The recording unit 10 may include (not shown separately) a general purpose programmable computer or a dedicated program computer including data storage and display devices, discussed further with respect to FIG. 3, that may perform a process according to the present invention and store and/or display the results of the process. However, the type of computer used to implement the invention and the type of display and/or storage devices are not limits on the scope of the present invention. In other embodiments, signals generated by sensors 12 may be transmitted by wireless transmitters to a receiver operably connected to recording unit 10. In still other embodiments, the electrical, magnetic and/or optical signals generated by sensors 12 are stored as data in solid state or other memory or recording devices associated with one or more sensors 12 for later processing.

Data recorded by data recording system 10 is typically, although not necessarily, in the form of digitally sampled time series referred to as seismic traces, with one time series or seismic trace for each sensor 12. Each value in the time series is recorded at a known time and represents the value of the seismic energy sensed by the sensor 12 at that time. The data are recorded over a period of time referred to as the data acquisition time period. The data acquisition time period varies depending on the objective of the seismic survey. In practicing the method of the present invention data may be recorded over a time period which may typically be a few hours. However, the data acquisition time period is not a limitation of the invention.

The rate at which data are recorded for each seismic trace for each of the sensors 12 may also be varied in accordance with the objectives of the survey and the frequency of the seismic energy generated in the formation. For example, if frequencies less than or equal to 125 Hz are expected to be sensed or measured, data may be sampled at a rate of 2.0 milliseconds (“ms”) for each trace to ensure aliasing does not occur. Other sample rates are also possible such as 0.25 ms, 0.5 ms, 4 ms, 8 ms, 16 ms and so on. It is usual to record more data than is required for a given survey objective. Once the seismic data have been recorded, they must be processed and converted to produce a useful display of information.

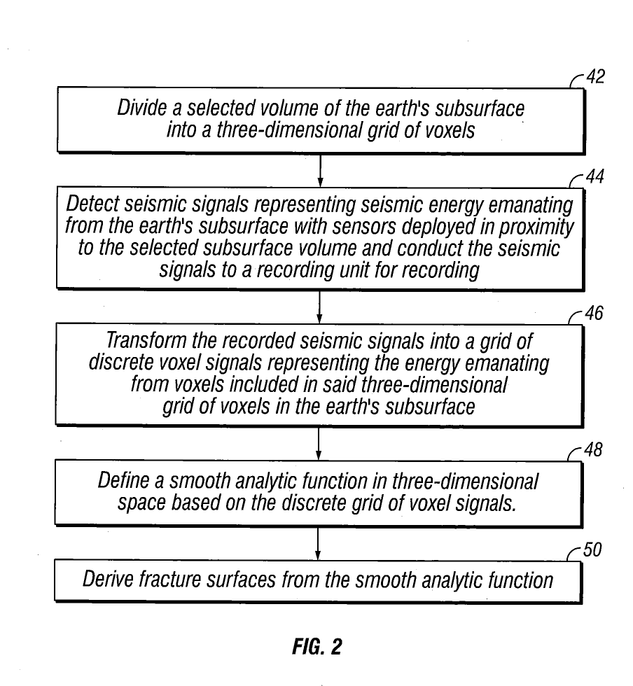

FIG. 2 is a flow chart that illustrates an embodiment of the invention in which fracture surfaces are extracted from passive seismic data (also referred to as microseismic data). In element 42, a selected volume of the earth's subsurface is divided into a three-dimensional grid of voxels. In element 44, seismic signals representing seismic energy emanating from said volume of the earth's subsurface and detected by sensors deployed in proximity to the selected subsurface volume are conducted to a recording unit for recording. In element 46 the recorded signals are transformed into a grid of discrete voxel signals representing the energy emanating from voxels included in said grid of voxels. In element 48 a smooth analytic function is defined in three spatial dimensions based on the grid of discrete voxel signals. In element 50 fracture surfaces are derived from the smooth analytic function.

In a particular implementation of the invention the signal detected by each sensor is recorded as a seismic data trace. To generate a discrete voxel signal representing the energy emanating from a specific subsurface voxel, the seismic data trace from a plurality of sensors are time aligned over a selected time window so that energy emanating from the specific voxel will be in time alignment. In a particular implementation of the invention semblance is used to calculate the magnitude of energy emanating from that specific voxel. This process is repeated for each subsurface voxel of interest to generate a data volume of discrete voxel signals. In other embodiments, the energy emanating from each subsurface voxel can be computed by employing stacking, stacking power, or cross-correlation instead of semblance to construct the discrete data volume from the microseismic trace data. In any of these cases, the energy emanating from each voxel is typically computed for many time windows to provide a higher number of estimated signal volumes, which are then summed to yield one final discrete data volume. The invention will be further described herein with the use of semblance. However, those of ordinary skill in the art will readily understand how to use stacking, stacking power, or cross-correlation or similar method for implementing the invention rather than using semblance.

In accordance with the method of this invention, fracture surfaces are extracted from the volume of discrete voxel signals. The actual fracture surfaces may not be located exactly on the three-dimensional grid of voxels, and in accordance with the invention, fracture surfaces are generated without regard to the grid coordinate system; that is, the fracture surface locations are independent of the grid location. Grid independence is achieved by defining a smooth analytic function in three-dimensional space that is representative of the microseismic grid data. The fracture surfaces are approximated by ridges of this smooth analytic function, embedded in a volume defined by the three spatial variables plus the analytic function value. To compute these fracture surfaces, minima of the three-dimensional second derivatives of the smooth analytic function are used to locate points on the ridges. In two spatial dimensions, a ridge of a function can be defined as a curve such that each point in the curve is a local maximum of the defined analytic function in the direction normal to the curve. In three spatial dimensions, a ridge of a function can be defined as a surface such that each point in the surface is a local maximum of the defined analytic function in the direction normal to the surface.

Fracture extraction can be performed according to the invention in two or three dimensions. The method is first described in two spatial dimensions for clarity and ease of illustration. However, the method is described in both two and three spatial dimensions.

In two spatial dimensions, (x, y), in an embodiment of the invention, the discrete voxel data used for fracture extraction is a semblance data volume, computed in the following way. Given a volume of microseismic trace data t_{x,y,m} at spatial locations (x, y) and time samples m, with 1≦m≦N, the discrete semblance data at sample (x, y, m) is defined by:

$${s}_{x , y , m} = \frac{{( {\sum }_{( {x}^{′} {y}^{′} )} \vert {t}_{{x}^{′} , {y}^{′} , m} \vert )}^{2}}{N {\sum }_{( {x}^{′} , {y}^{′} )} {t}_{{x}^{′} , {y}^{′} , m}^{2}} ,$$

The summations in the numerator and the denominator of the above equation over the traces t_{x′,y′,m} are over spatial locations (x′, y′) around spatial location (x, y) and over time samples in a time window around time sample m. Here, N is the number of traces used in the summation at spatial locations (x′, y′) within a prescribed aperture around spatial location (x, y). All traces at nearby (x′, y′) locations within the aperture are summed, but are not normalized by the number of such traces. The discrete semblance data are also stacked over a time window around each sample, in order to obtain smoother semblance with less impact from noisy samples. The discrete semblance data represents the energy of the stacked data (in the numerator) normalized by the mean energy of the components of the stack (in the denominator). In other embodiments, the energy emanating from each Cartesian grid voxel can be computed by employing stacking, stacking power, or cross-correlation instead of semblance to construct the discrete data volume from the microseismic trace data. In any of these cases, the energy emanating from each voxel is computed for many time windows to provide a higher number of estimated signal volumes, which are then summed to yield one final discrete data volume.

The discrete semblance data defined on a two-dimensional Cartesian grid are replaced by a smooth analytic function representation of the discrete semblance data. In this two spatial dimension example, a smooth semblance function s(x, y) is constructed from the discrete semblance function, now designated by sᵢⱼ(x, y). This smooth semblance function s(x, y) may be chosen in many ways known to those of ordinary skill in the art. In order for the method to work effectively, it is only necessary for the smooth semblance function s to have a curvature with local minima along the semblance ridges. For this reason, constructing an approximation of the discrete semblance data is not necessary, but rather a smooth function with curvature minima along the desired ridges is constructed. In one spatial dimension, the smooth semblance function may be defined by:

s(x)=ΣᵢsᵢΦᵢ(x),

where Φᵢ(x) is a smooth function having a peak at xᵢ and decaying away from xᵢ. The rate of decay determines whether the sum defining the smooth semblance function s(x) will have oscillations and hence spurious curvature minima. In a particular implementation of the invention the following function is used Φᵢ(x)=e^{-β|x-x}^{ᵢ}^{|}^{²} where β is a positive constant. In one embodiment, a value for β of approximately half the grid node spacing in the Cartesian grid of voxels was found to be effective. Extending to two and three dimensions, respectively, can be done with a tensor product of one-dimensional functions, given by:

Φᵢⱼ(x, y)=Φᵢ(x)Φⱼ(y),

Φᵢⱼₖ(x, y, z)=Φᵢ(x)Φⱼ(y)Φₖ(z).

Here, Φⱼ(y) and Φₖ(z) are defined analogously to Φᵢ(x).

In two spatial dimensions, the smooth semblance function s(x, y) can be used to define a semblance surface (x, y, s(x, y)), in which the fractures are one-dimensional curves in the x-y plane. Each fracture curve is a ridge of the surface, such that every point on the curve is a local maximum in the direction normal to the curve.

The approach taken for computing the ridges comprises finding local minima of the curvature of the semblance surface in the direction normal to the ridge curve. In one embodiment, computing the semblance ridges comprises an iterative scheme that first finds a suitable starting ridge point on a semblance surface ridge and then incrementally extends this first ridge point to a discrete set of points that approximates the ridge. One embodiment of this approach is described in more detail below. The incremental extensions are computed by searching in a neighborhood of the first point or an endpoint of the set of previously computed points on the ridge for a new point on or near the ridge. In one embodiment, a local minimum of the curvature of the smooth semblance function is found on a curve around the first point or an endpoint of the set of previously computed points on the ridge. In this way, a discrete set of points is computed lying approximately on the ridge, and the numerical representation of the ridge is computed as a piecewise smooth curve connecting these points.

The appropriate direction for computing the local minimum of the curvature of the smooth semblance function is normal to the ridge curve. The gradient of the smooth semblance function s is zero in the direction normal to the ridge curve, which can be given by ∇s·n=0, where n is the unit normal vector. Wherever ∇s≠0, in two spatial dimensions the normal to the ridge may be defined as the gradient ∇s rotated by π/2, given by:

$$n = \frac{1}{\vert ∇ s \vert} [ \begin{matrix}- {s}_{y} \\ {s}_{x}\end{matrix} ] .$$

This construction of the smooth semblance function s given above ensures that the gradient ∇s=0 can occur only at a finite number of isolated points, so that it may be assumed in the methods described below, that each computed ridge point satisfies ∇s≠0. If the location (x, y) happens to be at one of these finite number of points where ∇s=0, then a slight perturbation of that location will bring about ∇s≠0 and avoid any complications. Defining the Hessian matrix H of second partial derivatives by:

$$H = ( \begin{matrix}{s}_{xx} & {s}_{xy} \\ {s}_{yx} & {s}_{yy}\end{matrix} ) ,$$

the curvature in the direction normal to the ridge may be expressed as

$${c}_{n} ( x , y ) := ( Hn ) \cdot n = \frac{1}{{\vert ∇ s \vert}^{2}} ( {s}_{xx} {s}_{y}^{2} - 2 {s}_{xy} {s}_{x} {s}_{y} + {s}_{yy} {s}_{x}^{2} ) ,$$

provided that (x, y), is on the ridge. Thus we have cₙ(x, y), a smooth, analytic function representing curvature in the direction given by the normal n to the ridge, along the ridge. The fact that direction is built in to this curvature function makes it more convenient to work with than the smooth semblance function by itself. The ridges may be characterized approximately as the negative local minima of the curvature function cₙ(x, y). Note that the curvature minima are only approximations of the ridges, since they do not coincide exactly with local maxima of the smooth semblance function in general. However, the curves defined by minima of the curvature cₙ(x, y) have the same structure as the ridges and are close to the ridges.

In one particular embodiment, the method comprises computing a set of local minima of the curvature function cₙ(x, y), which is a set a of points (x, y) in two spatial dimensions at which the curvature function is a local minimum and negative. These local minima can be found by applying Newton's method to many initial starting points throughout the domain (for example all points on the data grid can be used as starting points for Newton's method). The extraction method will visit the local minima points in order according to their curvature function values, beginning at ther least (most negative).

For constructing the remaining points, the method is first extended in two spatial dimensions in a circle from this first point. In one embodiment, the extension distance is selected to be greater than the grid node spacing in the three-dimensional grid. The points around the circle are evaluated for the maxima of the minima of the curvature function cₙ(x, y). The highest maximum determines the next point to evaluate for the curvature function cₙ(x, y) and this next point is linked to the first point. Continuing, to find additional points in the first ridge curve segment, the method steps out recursively around a circle around each new point until a specified value of the minima of the curvature function cₙ(x, y) is reached. Then that first two dimensional ridge curve segment is terminated.

The next highest ranking point in the set S is selected. If this next point is contained within the two dimensional surface of the first ranked ridge curve segment just calculated above, then this next point is skipped. Otherwise, the above method is repeated to create a second two dimensional ridge curve segment. The second ridge curve segment is compared to the first ridge curve segment to determine if the ridge curve segments are the same. If not, then the ridge curve segments are merged. The above iteration is continued through the rank ordered points in S until exhausted. The ridge curve segments that result are compared as above and merged as necessary. The ridge curve segments correspond to the fracture curves.

In summary, the incremental search for constructing ridge curves in two spatial dimensions is to first, find a suitable starting point on each of the semblance ridges by finding local minima of the curvature cₙ(x, y) and then, incrementally extend the discrete set of ridge points on each semblance ridge, starting from the previous endpoint (x₀, y₀), and then finding a local minimum of the curvature cₙ(x, y) on a circle of small radius about the previous endpoint (x₀, y₀) on each semblance ridge. In the embodiment described above, the search for ridge points is systematically carried out in maximum to minimum order of the minima of the curvature function cₙ(x, y).

In three spatial dimensions, specifying the appropriate direction for the curvature is more complex. The smooth semblance function s(x, y, z) has the Hessian matrix

$$H = ( \begin{matrix}{s}_{xx} & {s}_{xy} & {s}_{xz} \\ {s}_{yx} & {s}_{yy} & {s}_{yz} \\ {s}_{zx} & {s}_{zy} & {s}_{zz}\end{matrix} )$$

of second partial derivatives. All of the derivatives and function evaluations involved can be computed analytically, since they all reduce to sums and products of derivatives of the analytic function, Φᵢⱼₖ(x, y, z), defined above. The curvature in the direction of any unit vector v is given by

(Hv)·v.

The ridges are considered as points for which the minimum negative curvature with respect to all directions is a local minimum, that is, the local minima of the function

cₘᵢₙ(x, y, z)=min_{|v|=1}(Hv)·v.

Employing a smooth semblance function ensures that functions, such as the minimum curvature function cₘᵢₙ(x, y, z) and its derivatives, are defined at every point in three-dimensional space. This evaluation need include points not covered by the input discrete semblance data determined at Cartesian grid voxels.

This minimum curvature function cₘᵢₙ(x, y, z) is equal to the minimum eigenvalue of the Hessian matrix H, which can be evaluated numerically. In an embodiment, Newton's method can be used to find minima of this minimum curvature function cₘᵢₙ(x, y, z). Whenever the gradient ∇s≠0, the unit vector v for which (Hv)·v attains its minimum (i.e., the eigenvector corresponding to the minimum eigenvalue of the Hessian matrix H) satisfies v·∇s=0. A maximum of the smooth semblance function s is attained at the ridge point in the direction of v, so its directional derivative v·∇s must vanish. Therefore, the negative minimum eigenvalue of H at a ridge point equals the minimum eigenvalue of the matrix HP, where P is the projection operator given by:

$$P = I - \frac{1}{{\vert ∇ s \vert}^{2}} ∇ s ∇ {s}^{T} ,$$

which removes components of vectors in the direction of ∇s. Since zero is an eigenvalue of HP, zero is a root of the characteristic polynomial of HP, given by:

p(μ)=det(HP−μI)=aμ³+bμ²+cμ+d=0.

Thus, μ=0 implies that d=0, and, after division by μ, the characteristic equation reduces to

aμ²+bμ+c=0.

Using the quadratic formula, the minimum eigenvalue of HP and hence of H is given by:

$${c}_{min} ( x , y , z ) = \frac{- b - \sqrt{{b}^{2} - 4 ac}}{2 a} .$$

If the entries of the 3-by-3 matrix HP are denoted by aᵢⱼ, then analytic expressions for the coefficients a, b, and c can be given by

a=−1,

b=a₁₁+a₂₂+a₃₃,

c=−a₁₁a₂₂−a₁₁a₃₃−a₂₂a₃₃+a₁₂a₂₁+a₁₃a₃₁+a₂₃a₃₂.

The Newton iteration formulas can be readily extended from two to three spatial dimensions. Additionally, minimizing cₘᵢₙ(x, y, z) on a circle is also useful in three spatial dimensions, as it was for two spatial dimensions, for extending computed fracture surfaces.

In two spatial dimensions, the ridges are curves. After finding a discrete set of points along the semblance ridges, the ridges may be approximated by piecewise smooth curves, such as by connecting the discrete ridge points by line segments. The ridge curves approximate the fracture curves. In three spatial dimensions, however, the ridges are surfaces, which can be approximated by triangulated surfaces consisting of the discrete ridge points. Triangulated surfaces are surfaces constructed from triangularly shaped surface elements. An incremental search, analogous to the incremental search described above for two spatial dimensions, is presented below. This incremental search will produce surfaces approximating the semblance ridges. Any remaining holes and gaps in the ridge surface may be filled in by triangularization. The ridge surfaces approximate the fracture surfaces.

In summary, the incremental search for constructing ridge surfaces in three spatial dimensions is to (1) find suitable starting points on each of the semblance ridges by finding local minima of the minimum curvature function cₘᵢₙ(x, y, z). Then, for each starting point, compute the eigenvector corresponding to the minimum (negative) eigenvalue of the Hessian matrix H. This eigenvector is normal to the ridge surface and defines the tangent plane to the ridge surface. Find an orthonormal basis for the tangent plane. (2) For each of the two tangent plane basis vectors, the span of the basis vector and the eigenvector is a plane perpendicular to the tangent plane. For each of these two perpendicular planes, define a circle of small radius about a boundary point (x₀, y₀, z₀) and find the two local minima of the minimum curvature function cₘᵢₙ(x, y, z). This yields four more points on the ridge surface, together with (x₀, y₀, z₀), which can be triangulated by four triangles to initialize the triangulated surface. (3) Incrementally extend the discrete set of triangles approximating the ridge surface from each boundary edge (having only one neighboring triangle), by finding a local minimum of the minimum curvature function cₘᵢₙ(x, y, z) on a circle of small radius about the boundary point (x₀, y₀, z₀) in the plane orthogonal to the boundary edge. This yields one new point on the ridge surface beyond the current set of triangles. Define a new triangle consisting of the boundary edge and the new point. (4) Triangulate any holes or gaps remaining, where point density is sufficient.

The first method for constructing fracture surfaces in three spatial dimensions will find a triangulated surface approximating each semblance ridge surface. However, step 3 can leave holes and gaps in the ridge surfaces, in particular near the intersections of ridge surfaces. These holes or gaps may be further triangulated, where point density is sufficient.

A second method for constructing fracture surfaces in three spatial dimensions is described here. The second method for constructing fracture surfaces in three spatial dimensions is designed to generate ridge surfaces without holes and gaps, in particular near the intersections of ridge surfaces.

The second method for constructing fracture surfaces in three spatial dimensions repeats steps 1 and 2 of the first method for constructing fracture surfaces in three spatial dimensions. For step 3 of the second method, the method of Hoppe, et al., 1992, is implemented with the modification of using marching tetrahedrally shaped surface elements (see Carneiro, et al., 1996) rather than marching cubes. This second method is well suited for parallel computations, since the marching tetrahedra or marching cubes methods require no parallel communication. Efficient computer parallelization is essential for computing large reservoir-scale fracture systems, with possibly millions of triangular surface elements in the triangulated surfaces. The incremental nature of the first method for three spatial dimensions inhibits computer parallelization. Although the first method may be used in the first step of the second method, it can be computer parallelized in this case without communication, since its input to the remainder of the second method (essentially just its points) may be permitted to have overlapping surfaces.

The following is a summary of the method of Hoppe, et al., 1992. A function ƒ:D→R is defined where D⊂R³ is a region rear the data, such that f estimates the signed geometric distance to the unknown surface M. Then, the zero set Z(f), the set of values for which the function f is zero, is an estimate of M. Zero is not a regular value of the (easier to estimate) unsigned distance function |f|, but zero is a regular value of the signed geometric distance function f, so that the zero function Z(f), the approximation to M, is a manifold and hence locally smooth. A contouring algorithm is then employed to approximate the zero function Z(f) by a simplicial surface, which is a piecewise linear surface with triangular faces.

To define the signed distance function f, an oriented tangent plane must first be associated with each of the data points of M. The tangent plane Tp(xᵢ) associated with the data point xᵢ∈X is represented as a point oᵢ, called the center, together with a unit normal vector nᵢ of the tangent plane. The center and unit normal for the tangent plane Tp(xᵢ) are determined by gathering together the k points of X nearest to xᵢ. This set of nearest points is called the k-neighborhood of xᵢ and is denoted by Nbhd(xᵢ). The center oᵢ and the unit normal nᵢ of the tangent plane Tp(xᵢ) are computed so that the plane {distᵢ(p)=0} is the least squares best fitting plane to Nbhd(xᵢ). The center oᵢ is the centroid of Nbhd(xᵢ) and the unit normal nᵢ is determined using principal component analysis, as follows. The covariance matrix CV of Nhbd(xᵢ) is given by:

$$CV = {\sum }_{y ∈ Nbhd ( {x}_{i} )} ( y - {o}_{i} ) ⊗ ( y - {o}_{i} )$$

where [symbol] denotes the vector outer product. If λᵢ¹≧λᵢ²≧λᵢ³ denote the eigenvalues of the covariance matrix CV associated with unit eigenvectors vᵢ¹, vᵢ², vᵢ³ respectively, then the unit normal is set to either vᵢ³ or vᵢ³, depending upon making the orientation of the tangent planes consistent with nearby planes.

The number k of nearest neighbors of xᵢ can be an input parameter or can be selected automatically by incrementally gathering points in the k-neighborhood while monitoring the changing eigenvalues of the covariance matrix CV.

If the data is dense and the surface is smooth, then for two data points xᵢ,xⱼ∈X, the corresponding tangent planes Tp(xᵢ)=(oᵢ,nᵢ) and Tp(xⱼ)=(oⱼ, nⱼ) should be nearly parallel. This means that n,ᵢ·nⱼ≈±1. Thus, the tangent planes should be oriented consistently to incorporate this. This can be accomplished as follows. First, the initial plane is the plane whose center has the largest z coordinate and the unit normal is oriented to point toward the +z axis. Then, the remaining tangent planes are traversed in depth-first order and assigned an orientation consistent with the orientation of the previously assigned tangent plane. Thus, the unit normal nⱼ of the next tangent plane Tp(xⱼ) is replaced with −hⱼ if nᵢ·nⱼ<0, where nᵢ is the unit normal for the previously assigned tangent plane Tp(xᵢ).

The signed distance function f(p) of a point p∈R³ to a known surface M is the distance between p and the closest point z∈M, multiplied by ±1. Since M is not known, M is approximated by the tangent plane Tp(xᵢ) whose center oᵢ is closest to p. The tangent planes are local linear approximations to M, so the signed distance function f(p) to M is approximated by the signed distance function between p and its projection z onto the tangent plane Tp(xᵢ). The projection z of the point p onto the tangent plane Tp(xᵢ) is given by:

z=oᵢ−((p−oᵢ)·nᵢ)nᵢ

If the Hausdorf distance d(z,X) is sufficiently small that the projection z is a point of M, then the signed distance function f(p) of the point p∈R³ to the tangent plane Tp(xᵢ)=(oᵢ,nᵢ) is defined by:

f(p)=distᵢ(p)=(p−oᵢ)·nᵢ.

The Hausdorff distance is the distance between the closest points of two sets.

Contour tracing is the extraction of an isosurface from a scalar function. A variation of the marching cubes algorithm samples the function at the vertices of a cubical lattice and finds the contour intersections within tetrahedral decompositions of the cubical cells. The signed distance function is only evaluated at points close to the data. The result is an approximation of the zero function Z(f) by a simplicial surface.

The second method for constructing fracture surfaces in three spatial dimensions is another method for construction of triangulated semblance ridge surfaces. (1) Find a discrete set S of closely spaced points spanning all semblance ridges. This can be done by applying the first method for three spatial dimensions or by finding local minima of the minimum curvature function cₘᵢₙ(x, y, z) using Newton's iteration method with many initial guesses in three spatial dimensions.

In one embodiment, the second method computes the minimum curvature function cₘᵢₙ(x, y, z) at the set of points S in the three spatial dimensions. The locations of the minima of the maxima of the minimum curvature function cₘᵢₙ(x, y, z) are found. These points in S are ordered in rank from maximum to minimum value of the minimum curvature function cₘᵢₙ(x, y, z). This second extraction method will visit these points in maximum to minimum order. The first point is selected as the highest ranked point with the highest ranked value of the minimum curvature function cₘᵢₙ(x, y, z) and the smooth semblance function s (x, y, z) is computed at this first point. Then the minimum curvature function cₘᵢₙ(x, y, z) is computed at this first point from the smooth semblance function s(x, y, z).

For constructing the remaining points, the method first extends in three spatial dimensions from this first point. In one embodiment, the extension distance is selected to be greater than the grid node spacing in the Cartesian grid. The points are evaluated for the maximum of the minimum curvature function Cₘᵢₙ(x, y, z). The highest maximum determines the next point to evaluate for the minimum curvature function cₘᵢₙ(x, y, z) and this next point is linked to the first point. Continuing, to find additional points in the first ridge surface segment, the second method steps out recursively around each new point until a specified value of the minimum curvature function cₘᵢₙ(x, y, z) is reached. Then that first three dimensional ridge surface segment is terminated.

The next highest ranking point in the set of points S is selected. If this next point is contained within the three dimensional surface of the first ranked ridge surface segment just calculated above, then this next point is skipped. Otherwise, the above method is repeated to create a second three dimensional ridge surface segment. The second ridge surface segment is compared to the first ridge surface segment to determine if the ridge surface segments are the same. If not, then the ridge surface segments are merged. The above iteration is continued through the rank ordered points in S until the list of points is exhausted. The ridge surface segments that result are compared as above and merged as necessary. The ridge surface segments correspond to the fracture curves.

The second method for constructing fracture surfaces in three spatial dimensions now continues. (2) Identify regions near surface intersections, and find a collection {Sᵢ} of maximal subsets of S not containing any points in regions near the intersections of ridge surfaces. If the first method for three spatial dimensions is used, this can be done by defining the maximal subsets {Sᵢ} by sets of points of connected triangles, such that neighboring triangles' normal vectors have an angle between them less than some specified value. That is, the maximal subsets {Sᵢ} are defined as surfaces where the normal vector does not change too rapidly. Alternatively, the spatial rate of change of the normal direction can be evaluated for the set S by finding an average tangent plane at each point in S, based on the neighboring points within some radius (see section 3.2 of Hoppe). (3) Use a method, such as marching tetrahedra, to construct a surface from each maximal subset of points {Sᵢ}. Extend the constructed surfaces until they intersect (in the marching tetrahedra method, it is easy to extend surfaces tangentially beyond the set of points which they approximate).

The geometry of the constructed fractures has multiple applications. Cumulative seismic activity may be used as a proxy for the slip-tendency of the fracture, so that the orientation and activity values of all the fracture surfaces can be inverted for the orientations and relative magnitudes of the neostresses (stresses at the present time). The fracture surfaces are connected and can be exported and used directly in Discrete Fracture Network (DFN) fracture and reservoir simulations. Surface statistics are used for calibrating stochastic DFN fracture and reservoir simulators, interpreting focal mechanism solutions, and understanding the interaction of hydraulic fractures with pre-existing natural fracture networks. A discrete representation of the fracture surfaces allows for visualization of the fractures, helping geologists and reservoir engineers understand and measure the extent and the effectiveness of the network.

The foregoing embodiments of methods according to the various aspects of the invention may be performed by a suitable programmed general purpose computer. As example of such a computer having a central processor 150 is shown in FIG. 3. The processor 150 is coupled to a user input device 154 such as a keyboard, and is coupled to a display 152 such as a flat panel liquid-crystal display (LCD). A computer program according to this aspect of the invention may reside on any one of a number of types of computer readable medium, such as compact disk 162 insertable into a CD reader 156 or the program may reside in a hard drive 160 within or remote from the processor 150. The program includes logic operable to cause a programmable computer to perform the data processing sequences described above. The particular embodiment in which a computer program is stored is not meant to limit the scope of the invention. The computer may form part of the recording unit (10 in FIGS. 1A and 1B) or may be another computer.

In another aspect, the invention relates to computer readable media storing thereon a computer program for carrying out the method described above with reference to FIG. 2. Referring to FIG. 3, the foregoing process as explained with reference to FIGS. 2 and 3 can be embodied in computer-readable code. The code can be stored on a computer readable medium, such as CD-ROM 164 or a magnetic hard drive 160 forming part of a general purpose programmable computer. The computer, as known in the art, includes a central processing unit 150, a user input device such as a keyboard 154 and a user display 152 such as a flat panel LCD display. According to this aspect of the invention, the computer readable medium includes logic operable to cause the computer to execute acts as set forth above and explained with respect to the previous figures.

Typically the fracture surfaces generated according to the present invention will be displayed on a user display such as a flat panel LCD display or printed as a tangible copy. The purposes of this invention are for guidance in determining where to drill a wellbore for producing hydrocarbons and in managing the production of existing wells.

While the invention has been described with respect to a limited number of embodiments, those skilled in the art having the benefit of this disclosure, will appreciate that other embodiments can be devised which do not depart from the scope of the invention as disclosed herein.

What is claimed is:

1. A method of imaging a volume of the earth's subsurface, comprising:
dividing a selected volume of the earth's subsurface into a three-dimensional grid of voxels;
conducting seismic signals representing seismic energy emanating from the earth's subsurface and detected by sensors deployed in proximity to said selected subsurface volume to a recorder for recording:
transforming the recorded signals into a grid of discrete voxel signals representing energy emanating from voxels included in said three-dimensional grid of voxels in the earth's subsurface;
defining a smooth analytic function in three dimensional space based on the grid of discrete voxel signals; and
deriving fracture surfaces from the smooth analytic function.

2. The method of claim 1 wherein fracture surfaces in two spatial dimensions are derived from the smooth analytic function

3. The method of claim 1 wherein fracture surfaces in three spatial dimensions are derived from the smooth analytic function.

4. The method of claim 2 wherein fracture surfaces are approximated by ridges of the smooth analytic function, said ridges being curves such that each point in the curve is a local maximum of the defined analytic function in the direction normal to a curve.

5. The method of claim 3 wherein fracture surfaces are approximated by ridges of the smooth analytic function, said ridges being surfaces such that each point in the surface is a local maximum of the defined analytic function in the direction normal to the surface.

6. The method of claim 4 wherein said grid of discrete voxel signals is semblance data and a smooth semblance function is constructed from the semblance data and the smooth semblance function is used to define a semblance surface in which the fractures are one-dimensional curves in the x-y plane, each fracture curve being a ridge on the surface, such that every point on the curve is a local maximum in the direction normal to the curve.

7. The method of claim 6 wherein computing the ridges comprises an iterative scheme that first finds a suitable starting ridge point on a surface ridge and then incrementally extends this first ridge point to a discrete set of points that approximates the ridge.

8. The method of claim 5 wherein said grid of discrete voxel signals is semblance data and a smooth semblance function is constructed from the semblance data and a semblance surface is constructed in which the ridges are surfaces which can be approximated by triangular surfaces consisting of the discrete ridge points.

9. The method of claim 8 further comprising: finding suitable starting points on each of the semblance ridges by finding local minima of the minimum curvature function cₘᵢₙ(x, y, z); then for each starting point, computing the eigenvector corresponding to the minimum eigenvalue of the Hessian matrix H, said eigenvector being normal to the ridge surface and defining a tangent plane to the ridge surface; finding an orthonormal basis for the tangent plane, for each of the two tangent plane basis vectors, the span of the basis vector and the eigenvector being a plane perpendicular to the tangent plane; for each of the two perpendicular planes defining a circle of small radius about a boundary point (x₀, y₀, z₀) and find the two local minima of the minimum curvature function cₘᵢₙ(x, y, z); thereby yielding four more points on the ridge surface, together with (x₀, y₀, z₀) which can be triangulated by four triangles to initiate the triangulated surface.

10. The method of claim 9 further comprising incrementally extending the discrete set of triangles approximating the ridge surface from each boundary edge (having only one neighboring triangle), by finding a local minimum of the minimum curvature function cₘᵢₙ(x, y, z,); on a circle of small radius about the boundary point (x₀, y₀, z₀) in the plane orthogonal to the boundary edge, defining a new triangle consisting of the boundary edge and the new point and triangulate any holes or gaps remaining where point density is sufficient.
